(19) United States
(12) Patent Application Publication
(10) Pub. No.: US 2002/0173182 A1
(43) Pub. Date: Nov. 21, 2002

(54) Molded connector assembly for making electronically conductive connections with components in a vehicle engine compartment

(76) Inventor: Ki-Ho Lee, Windsor (CA)

Correspondence Address: LAURA M. SLENZAK, SIEMENS CORPORATION, 186 WOOD AVENUE SOUTH, ISELIN, NJ, 08830, US

(21) Appl. No.: 10/124,495

(22) Filed: Apr. 17, 2002

Related U.S. Application Data
(60) Provisional application No. 60/290,924, filed on May 15, 2001.

(51) Int. Cl. H01R 13/44

(52) U.S. Cl. 439/130

(57) ABSTRACT

An electrical connector (20) for providing electrical energy to a plurality of components (44, 46) supported in a vehicle engine compartment includes a body (22) that supports at least one conductor (24). In one example, the body is a plastic molded portion that completely encases the conductor and has connection terminals (28-34) for making electrical connections with the desired components. A plurality of conductors or a single communication bus conductor may be supported within the body. Electrical connections with component assemblies, such as fuel injector assemblies, can be completed by a component supplier before shipment to a vehicle manufacturer.

### CROSS-REFERENCE TO RELATED APPLICATIONS

This application claims priority to U.S. Provisional Application Serial No. 60/290,924, which was filed on May 15, 2001.

### BACKGROUND OF THE INVENTION

This invention generally relates to electrical connection assemblies for providing electrical energy to components in a vehicle engine compartment. More particularly, this invention relates to a molded electrical connection assembly.

A variety of components within vehicle engine compartments (i.e., under the hood) require electrical energy to receive power, control signals or both. The conventional approach is to use wire harnesses to provide the conductors necessary to communicate the required electrical energy to the various components. Wire harnesses have been used because they provide a flexibility or resiliency that accommodates the vibrations typically occurring in a vehicle engine compartment.

Disadvantages associated with wire harnesses include their relatively complex arrangement which is increasing with the increasing amount of electronics incorporated into vehicles, Accordingly, wire harnesses are becoming more and more difficult to assemble and arrange. Conventional wire harness connections also introduce additional costs because of the quality of the wires required, especially wire harnesses placed within the vehicle engine compartment. Conventional wire harnesses include 16 or 18 gauge wires, each of which typically is made from at least 7 strands of copper.

Those skilled in the art are always striving to make improvements. There is a need for an improved electrical connection arrangement that is usable within a vehicle engine compartment for providing electrical energy to a plurality of components in the engine compartment. This invention addresses that need while avoiding the shortcomings and drawbacks of conventional approaches.

### SUMMARY OF THE INVENTION

In general terms, this invention is an electrical connector assembly having a molded body that supports at least one conductor for supplying electrical energy to a plurality of components within a vehicle engine compartment.

One particular application of this invention is to use a single connector assembly for providing the electrical connections needed to operate fuel injectors in a fuel injector assembly. In such an example embodiment of this invention, the assembly includes a fuel rail and a plurality of fuel injectors supported on the rail. A molded electrical connector has a body supporting the electrical conductor. A plurality of connection terminals on the molded connector couple the fuel injectors to a source of electrical energy.

The molded connector body supports the connection terminals at fixed locations relative to each other. The connector terminals preferably are set at a spacing that corresponds to the spacing between electrical connection ports on the fuel injectors when they are fixed to the fuel rail. The completed assembly provides a rigid connection between the fuel rail and the fuel injectors and between the fuel injectors and the electrical connector. Therefore, the preferably rigid electrical connector establishes a robust connection with the fuel injector and fuel rail assembly.

According to this invention, it is possible to pre-assemble an entire fuel injector assembly including the electrical connections to each of the injectors prior to shipping the assembly to a vehicle or engine manufacturer. Prior to this invention, the injector assemblies were shipped and wire harness connections were made at the vehicle manufacturer's facilities. The ability to pre-assemble the electrical connections to the fuel injectors enhances manufacturing economies.

The various features and advantages of this invention will become apparent to those skilled in the art from the following detailed description of the currently preferred embodiments. The drawings that accompany the detailed description can be briefly described as follows.

### BRIEF DESCRIPTION OF THE DRAWINGS

FIG. 1 schematically illustrates an electrical connector assembly designed according to this invention.

FIG. 2 schematically illustrates a fuel injector assembly incorporating an electrical connector designed according to this invention.

### DETAILED DESCRIPTION OF THE PREFERRED EMBODIMENTS

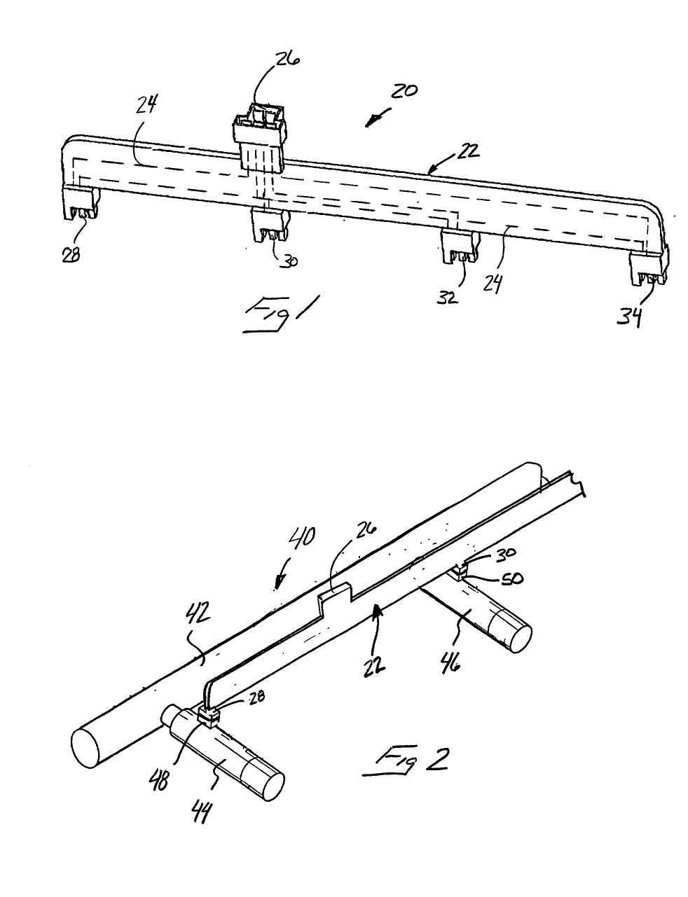

FIG. 1 illustrates an example connector 20 designed according to this invention. The connector 20 includes a connector body 22 which, in one example, is made from a plastic material. A molded plastic material is believed advantageous for its low cost and lightweight features.

The body 22 supports at least one electrically conductive conductor 24. In one example, the body 22 is molded over the conductor 24.

In the illustrated example, a plurality of conductors 24 are shown. In one example, a single bus communication line conductor is supported within the body 22. In one example, a stamped single conductive piece of material is supported within the body 22 to provide a bus communication line.

The illustrated example includes a main connection port 26 that is adapted to be coupled to a source of electrical energy (i.e. communication signals, power or both) that is supported elsewhere on the vehicle. A plurality of connection terminals 28, 30, 32 and 34 are positioned to make a selected connection with a plurality of components supported within the vehicle engine compartment.

One particular application for this invention is in fuel injector assemblies. An example fuel injector assembly 40 is shown in FIG. 2. A fuel rail 42 supports a plurality of fuel injectors 44 and 46 in a conventional manner. The electrical connector 20 facilitates providing electrical energy (i.e. control signals, power or both) to the fuel injectors 44 and 46 so that the injectors can operate in a desired fashion. The connection terminals 28 and 30 shown in FIG. 2 are spaced apart a distance from each other that corresponds to a spacing between electrical connection ports 48 and 50 on the injectors 44 and 46, respectively. The body 22 preferably is molded and provided with the connection terminals at selected locations that correspond to the positioning of the connection ports 48 and 50 of the fuel injectors.

Once the assembly of FIG. 2 is fitted together, the entire assembly is rigid and provides a robust, reliable electrical connection between the connector 20 and the fuel injectors of the assembly. Because the connector 20 is rigid and rigidly secured to the fuel injectors, which are rigidly supported on the rail 42, the vibrations experienced in the engine compartment are not problematic.

This invention provides several advantages compared to prior wire harnessing arrangements. One advantage is that a single strand wire conductor can be supported at least partially within the body 22. This reduces the weight and cost of the electrical conductor needed to properly operate fuel injectors or other components in the vehicle engine compartment. Integrating the electrical connector with a fuel injector assembly prior to shipping the assembly to a vehicle manufacturer enhances manufacturing economies and allows the component supplier to verify proper electrical connections are made prior to shipment.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A fuel injector assembly, comprising:
a fuel rail;
a plurality of fuel injectors supported on the rail;
a molded electrical connector having a body supporting at least one electrical conductor and a plurality of connection terminals coupled with the injectors such that electrical energy on the conductor is provided to the injectors.

2. The assembly of claim 1, wherein the connector body comprises a molded plastic at least partially encasing the conductor.

3. The assembly of claim 2, wherein the conductor comprises a communication bus.

4. The assembly of claim 1, wherein the conductor comprises a single strand wire.

5. The assembly of claim 1, wherein the conductor comprises a single stamped piece of a conductive metallic material.

6. The assembly of claim 1, wherein the fuel injectors each have an electrical connection port that is spaced from the other ports a selected distance and wherein the connection terminals are spaced apart a set distance corresponding to the spacing between the connection ports.

7. A method of assembling a fuel injector assembly, comprising the steps of:
providing a fuel rail, a plurality of fuel injectors and a communication bus having a body supporting at least one electrical conductor;
supporting the fuel injectors on the fuel rail; and
attaching the communication bus to the fuel injectors prior to shipping the assembly to a vehicle manufacturer.

8. The method of claim 7, including establishing a rigid connection between the fuel injectors and the fuel rail and between the communication bus and the fuel injectors such that the entire assembly is generally rigid.

9. A method of making an electrical connector for use within a vehicle compartment of a vehicle, comprising the steps of:
determining a placement of a plurality of components within the engine compartment relative to each other;
molding a plastic body including forming a plurality of connection terminals on the body in a placement relative to each other corresponding to the determined placement of the components; and
supporting at least one electrical conductor within the body.

10. The method of claim 9, including using a single strand of conductive wire as the conductor.

11. The method of claim 9, including using a stamped conductive material as the conductor.

12. The method of claim 9, including forming a main connection port on the housing that is adapted to be coupled with a source of electrical energy.

13. The method of claim 9, including supporting a plurality of conductors within the body and associating each of the conductors with at least a corresponding one of the connection terminals.
